(19) United States
(12) Patent Application Publication
(10) Pub. No.: US 2023/0393531 A1
(43) Pub. Date: Dec. 7, 2023

(54) STRAP WITH UPPER AND LOWER COVERS

(71) Applicant: Cuiyuan LONG, Liuzhou (CN)

(72) Inventor: Cuiyuan LONG, Liuzhou (CN)

(21) Appl. No.: 18/453,851

(22) Filed: Aug. 22, 2023

(51) Int. Cl. G04B 37/14; A44C 5/14

(52) U.S. Cl. CPC G04B 37/1486; A44C 5/14

(57) ABSTRACT

The application relates to the technical field of watches, and particularly to a wristband integrated with upper and lower covers. The wristband comprises a strap with an integrated upper and lower cover, a watch case and an integrated strap assembly with an upper and lower cover. The upper part of the watch case is provided with a PC case. The outer surface of the watch case is provided with a watch strap, the outer surface of the watch case is fixedly provided with a bump, the groove is provided on the outer side of the PC case, and the bump is inserted into the inside of the groove. The watch case is provided at one end of the strap, and the watch case and the strap are integrated together, the watch case can be effectively prevented from falling off from the watch strap.

### TECHNICAL FIELD

The application relates to the technical field of watches, and particularly to a watch strap with an upper and lower cover.

### BACKGROUND OF THE PRESENT INVENTION

Traditional wearable accessories, PC case and watch strap is used independently, and the watch strap contains a unique connector, the separation of the watch frame is easy to fall off or be lost. During assembling, the watch strap is provided on the smart watch through the connecting pin, but during wearing, when the strap is pulled, the tension is generated on the connecting pin. If the connecting pin is broken or bent, the strap will fall off from the smart watch, and the wearing is affected, so a watch strap with an upper and lower cover is invented to solve the above problems.

### SUMMARY OF PRESENT INVENTION

In order to make up for the above deficiencies, the application provides a wristband with an integrated upper and lower cover which overcomes the above technical problems or at least partly solves the above problems.

The application is achieved as below:

The application provides a wristband with an upper and lower cover, comprising a watch case, and a PC case is provided on the upper part of the watch case: An upper and lower cover integrated strap assembly, the upper and lower cover integrated strap assembly comprising:

A smart watch, the smart watch is socketed on the outside of the watch case, and a watch strap is installed on the outer side of the watch case;
A bump, the outer surface of the watch case is fixedly provided with the bump;
A groove, the groove is provided on the outer surface of the PC case, and the protrusion is inserted into the groove.

In a preferred solution, the watch case and the strap are integrated, and a through hole is provided on the outer surface of the watch case, and an adjustment button is arranged inside the through hole, and the adjustment button is arranged on the smart watch.

In a preferred solution, a convex groove is provided on the outer surface of the watch case, a limiting groove is fixedly provided on the outer surface of the PC case, and the convex groove is inserted into the limiting groove.

In a preferred solution, the watch case is sleeved on the bottom of the smart watch, the PC case is sleeved on the upper part of the smart watch, and the PC case and the watch case are interlaced.

In a preferred solution, a mounting hole is defined on one side of the PC case, and the adjusting button penetrates through the inside of the mounting hole.

The application provides a wristband integrated with upper and lower covers, and the beneficial effects comprise:
1. The watch case is provided on one end of the strap, and the watch case and the strap are integrated, the watch case is effectively prevented from falling off the strap. At the same time, the smart watch is provided inside the watch case. The PC case is socketed on the outer side of smart watch, and the case and the PC case are connected together, so that the smart watch can be stably provided inside the case, and at the same time, the smart watch is protected from being bumped or worn, and meets the requirements of use.
2. The device uses the protrusion to insert the groove and the convex groove into the inside of the limiting groove, which is convenient for the PC case to be stably provided on the watch case, and it is also convenient to remove the PC case to replace the desired PC shell, so as to meet the use.

### DESCRIPTION OF THE DRAWINGS

In order to more clearly illustrate the technical solutions of the embodiments of the present invention, the following drawings will be briefly introduced in the embodiments. It should be understood that the following drawings only show some embodiments of the present invention. Therefore, it should not be regarded as a limitation on the scope. For those skilled in the art, other related drawings can also be obtained according to these drawings without creative work;

FIG. 1 is a schematic diagram of the main view structure of the application;

FIG. 2 is a schematic diagram of the explosion structure of the application;

FIG. 3 is the structural schematic diagram of watch case of the application;

FIG. 4 is a structural schematic diagram of the bottom of the watch case of the application;

In the figure: 1. Watch case; 2. PC case; 3. Integrated strap assembly with upper and lower covers; 31. Smart watch; 311. Watch strap; 32. Protrusion; 33. Groove; 4. Through hole; 5. Adjustment Button; 6. Convex groove; 7. Limiting groove; 8. Mounting hole; 9. Converging sleeve; 10. Needle hole.

### DETAILED DESCRIPTION OF PREFERRED EMBODIMENTS

In order to make the purposes, technical solutions and advantages of the embodiments of the application clearer, the technical solutions in the embodiments of the application will be clearly and completely described below in conjunction with the accompanying drawings in the embodiments of the application. Obviously, the embodiments described above are some of the embodiments of the present application, but not all of them. Based on the embodiments of the application, all other embodiments obtained by persons of ordinary skill in the art without making creative efforts belong to the scope of protection of the application.

### Embodiment

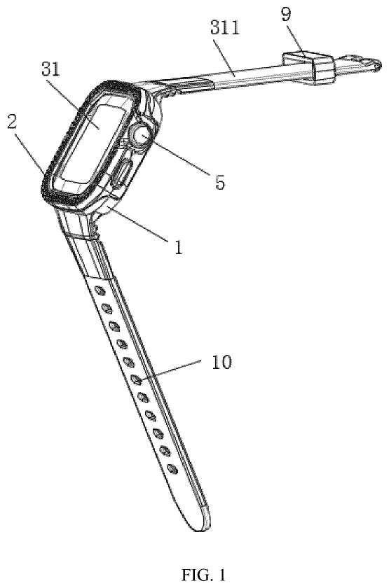

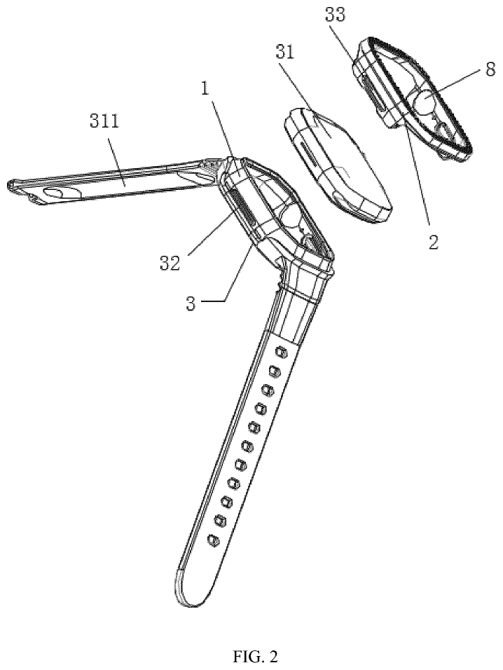

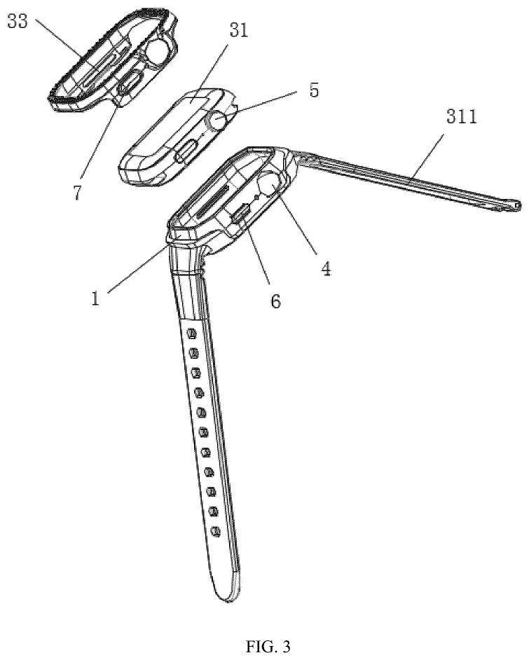

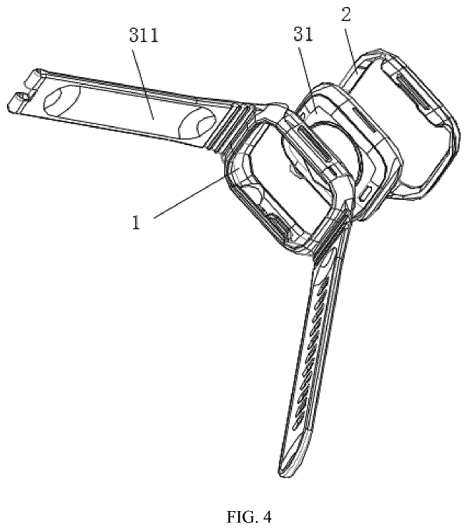

Referring to FIG. 1-FIG. 4, the application provides a technical solution: a watchband integrated with upper and lower covers, comprising a watchcase 1 and a watchband assembly 3 with an integrated upper and lower cover, and a PC case 2 is provided on the upper part of the watchcase 1, so that the upper and lower cover integrated strap assembly 3 comprises a smart watch 31, the smart watch 31 is sleeved on the outside of the watch case 1, a watch strap 311 is provided on the outer surface of the watch case 1. The protrusion 32 is installed on the outer surface of the watch case 1, the groove 33 is provided on the outer surface of the PC case 2, and the protrusion 32 is inserted into the groove 33.

Through the combined use of the above structure, not only the watch case 1 can be prevented from falling off from the strap 311, but also the smart watch 31 can be protected. Specifically, the smart watch 31 can be protected inside the watch case 1. the smart watch 31 is clamped, then the PC case 2 is provided on the watch case 1, and socket it on the outside of the smart watch 31, so that the smart watch 31 can be stably placed inside the watch case 1, and at the same time, according to preferences, the PC case 2 can be replaced, so as to satisfy people's use.

Since the corners of the smart watch 31 are wrapped by the watch case 1 and the PC case 2, when the watch is worn, the smart watch 31 can be prevented from being rubbed, and the outer surface of the smart watch 31 is prevented from being scratched, which affects the appearance.

In a preferred embodiment, the watch case 1 and the strap 311 are integrated, the outer surface of the watch case 1 is provided with a through hole 4, and the inside of the through hole 4 is provided with an adjustment button 5, the adjustment button 5 is arranged on the smart watch 31. In order to facilitate the manipulation of the adjustment button 5, the device is provided with a through hole 4 on the watch case 1, and the adjustment button 5 is installed inside the through hole 4, so that the adjustment button 5 is exposed. The adjustment button 5 can be conveniently operated, so that the time displayed on smart watch 31 can be adjusted.

In a preferred embodiment, the outer surface of the watch case 1 is provided with a convex groove 6, the outer surface of the PC case 2 is fixedly installed with a limiting groove 7, and the convex groove 6 is inserted into the inside of the limiting groove 7, In order to improve the stability of the connection between the case 1 and the PC case 2, a convex groove 6 is provided on the outer surface of the case 1, and a limiting groove 7 is installed on the outer surface of the PC case 2. The convex groove 6 is placed into the groove 7, the PC case 2 and the watch case 1 can be stably connected together.

In a preferred embodiment, the watch case 1 is socketed on the bottom of the smart watch 31, the PC case 2 is socketed on the upper part of the smart watch 31, the PC case 2 and the watch case 1 are interlaced, and the device Not only is it convenient to install the smart watch 31, but it can also protect the smart watch 31. The bottom of the smart watch 31 is provided inside the watch case 1, and the upper part of the smart watch 31 is installed inside the PC case 2, the smart watch 31 can be protected. To avoid bumping or wearing the outer surface of the smart watch 31.

In order to expose the adjustment button 5 on the smart watch 31, an installation hole 8 is provided on one side of the PC case 2, the adjustment button 5 penetrates the inside of the installation hole 8, and the adjustment button 5 will pass through the inside of the PC case 2 exposed so that the wearer can operate the adjustment button 5.

The strap 311 of the watch is worn on the wrist, and the strap 311 wraps around the wrist. In order to limit the position of the end of the strap 311 and prevent it from lifting, a shrink sleeve 9 is provided on the outer surface of the strap 311. Several needle holes 10 are provided on the outer surface of the watch strap 311, and are evenly arranged on the outer surface of the watch strap 311. In actual usage, one end of the watch strap 311 is limited by the tightening sleeve 9, the end of the watch strap 311 is effectively prevented from lifting, meeting the requirements of usage.

Specifically, the working process or working principle of a strap with an integrated upper and lower cover is as follows: the traditional wearable accessories, the PC case 2 and the smart watch are used independently and separately, and the strap 311 contains a unique connector, the watch frame Separation is easy to cause falling off or loss. During assembling, the strap 311 is provided on the smart watch through the connecting pin for use. However, during wearing, when the strap 311 is pulled, the tension is generated on the connecting pin, if the connecting pin breaks or bends, the strap 311 will fall off from the smart watch, which will affect the wearing. Therefore, the device is designed to solve this problem. The smart watch 31 is placed inside the watch case 1. The inside of the watch case 1 in this device is provided as hollow, and the bottom is provided as an opening, but there are supporting parts on the side, so when the smart watch 31 is placed inside the watch case 1, it will be held up. Lift the smart watch 31 up, and the smart watch 31 can be provided inside the watch case 1.

In order to stably install the smart watch 31 inside the watch case 1, after the smart watch 31 is provided inside the watch case 1, the PC case 2 can be socketed on the upper part of the smart watch 31, and the display screen on the smart watch 31 is exposed, which is convenient for observing the time. By inserting the protrusion 32 on the side of the watch case 1 into the inside of the groove 33, one side of the PC case 2 is connected with the side of the watch case 1, and then the convex groove 6 is connected with the inside of the limit slot 7, the other side of the PC case 2 can be connected with the other side of the watch case 1, and at the same time, the side position of the PC case 2 is socketed on the side of the smart watch 31, the smart watch 31 is prevented from bumping or friction during wearing, and the smart watch 31 is prevented from being damaged.

By connecting the PC case 2 with the watch case 1, the smart watch 31 can be stably provided inside the watch case 1, and then the watch strap 311 can be worn on the arm for usage.

The watch case 1, watch strap 311, PC case 2 and constricting sleeve 9 in the device are made of uniform silica gel material, have certain toughness, and are convenient for installing the smart watch 31 and the PC case 2, and the PC case 2 can be easily removed from the watch case 1. So you can choose a suitable PC case 2 to arrange on the watch case 1 according to your preferences, easy to use.

I claim:

1. The wristband with upper and lower covers, characterized in that comprising a watch case (1), and a PC case (2) is provided on the upper part of the watch case (1).
An upper and lower cover integrated strap assembly (3), the upper and lower cover integrated strap assembly (3) comprises:
A smart watch (31), the smart watch (31) is sleeved on the outside of the watch case (1), and a strap (311) is provided on the outer surface of the watch case (1).
A bump (32), the outer surface of the watch case (1) is fixedly provided with the bump (32);
A groove (33), the groove (33) is provided on the outer surface of the PC case (2), and the protrusion (32) is plugged into the groove (33).

2. The strap with an integrated upper and lower cover according to claim 1, characterized in that the watch case (1) and the watch strap (311) are integrated, and the outer surface of the watch case (1) is provided with a through hole (4), an adjustment button (5) is arranged inside the through hole (4), and the adjustment button (5) is arranged on the smart watch (31).

3. The wristband with upper and lower covers according to claim 2, characterized in that, the watch case (1) is provided with convex grooves (6), and the outer surface of the PC case (2) is fixedly provided on the limiting groove (7), the convex groove (6) is plugged into the limiting groove (7).

4. The strap with integrated upper and lower covers according to claim 3, characterized in that, the watch case (1) is socketed on the bottom of the smart watch (31), and the PC case (2) is socketed on the smart watch on the upper part of the watch (31), the PC case (2) and the watch case (1) are interrelatedly connected.

5. The wristband with upper and lower covers according to claim 4, characterized in that, one side of the PC case (2) is provided with a mounting hole (8), and the adjustment button (5) penetrates the mounting hole (8)) internal.

6. The strap with integrated upper and lower covers according to claim 5, characterized in that, the outer surface of the strap (311) is slidably mounted with a constricting sleeve (9), and several pinholes (10) are provided and evenly arranged on the outer surface of the strap (311).
